(19) United States
(12) Patent Application Publication
(10) Pub. No.: US 2020/0157879 A1
(43) Pub. Date: May 21, 2020

(54) VENETIAN BLIND RETRACTING MECHANISM

(71) Applicant: Zheng Bang LEI, Shenzhen (CN)

(72) Inventor: Zheng Bang LEI, Shenzhen (CN)

(21) Appl. No.: 16/368,733

(22) Filed: Mar. 28, 2019

(30) Foreign Application Priority Data
Nov. 19, 2018 (CN) 201821903953.9
Mar. 19, 2019 (CN) 201920349554.0

(51) Int. Cl. E06B 9/322

(52) U.S. Cl. CPC E06B 9/322

(57) ABSTRACT

A venetian blind retracting mechanism used for blinds includes a spring box element and guiding elements installed on both sides of the spring box respectively. The spring box element includes a casing, a winding wheel set pivoted to the casing, spring seats disposed on both sides of the winding wheel set respectively, and a worm spring wound around the spring seat. The winding wheel set includes two winding wheels engaged with each other through a gear and coaxially coupled to a winding shaft, and an end of the worm spring is engaged with the winding wheel. This invention overcomes the issue of the conventional venetian blind retracting mechanism requiring a complicated transmission structure to wind or rewind two drawstrings simultaneously. The simple transmission structure formed by the spring box element and the guiding element reduces the number of components to avoid asynchronous operations caused by too many components.

### FIELD OF THE INVENTION

The present invention relates to the field of curtains, and more particularly to a venetian blind retracting mechanism.

### BACKGROUND OF THE INVENTION

Venetian blind is one of the common curtains, and a venetian blind retracting mechanism is generally used for retracting the venetian blind.

With reference to FIG. 1 for a conventional venetian blind 6, the venetian blind 6 comprises two or more vanes 61 and two drawstrings 62; all vanes 61 are arranged sequentially in the vertical direction and parallel to each other; both ends of the venetian blind 6 have a drawstring 62 each (in other words, there are two drawstring 62 disposed at both ends of the venetian blind 6 respectively); each of the vanes 61 except the last one at the bottom of the venetian blind 6 has a vane through-hole 611 formed at the same position at both ends of the vane 61 separately, and the two drawstrings 62 are passed vertically through the vane through-holes 611 of all vanes 61, and the ends of the two drawstrings 62 are coupled to the last vane 61 at the bottom of the venetian blind 6. The front ends of the two drawstrings 62 are passed out from the first vane 61 at the top of the venetian blind 6. If the front end of the drawstring 62 is pulled, the last vane 61 at the bottom will be pulled first and then the rest of the vanes of the venetian blind 6 will be pulled from the bottom to the top.

By winding or rewinding the front end of the drawstring 62, the venetian blind retracting mechanism achieves the effect of retracting the venetian blind. If it is necessary to prevent tilting the venetian blind 6 during the retracting process, both drawstrings 62 must be wound or rewound simultaneously. Since the distance between the two drawstrings 62 is relatively far from each other, the venetian blind retracting mechanism needs a more complicated transmission structure to achieve the effect of winding or rewinding the two drawstrings 62 simultaneously, which may bring up the issues of having too many components of the venetian blind retracting mechanism and causing an asynchronous operation.

### SUMMARY OF THE INVENTION

Therefore, it is a primary objective of the present invention to overcome the aforementioned drawbacks of the prior art by providing a venetian blind retracting mechanism capable of winding or rewinding two drawstrings simultaneously and making the transmission structure simple and compact.

To achieve the aforementioned and other objectives, the present invention provides a venetian blind retracting mechanism, for retracting a venetian blind, and the venetian blind comprising two or more vanes and drawstrings; and both ends of the venetian blind having the drawstrings passing through all of the vanes and coupled to the last vane at the bottom of the venetian blind; characterized in that the venetian blind retracting mechanism comprises a spring box element and a guiding element separately disposed on both sides of the spring box element; the spring box element comprises a casing, a winding wheel set pivotally coupled to the casing and separately disposed at a spring seat on both sides of the winding wheel set, and wound around a worm spring installed on the spring seat; the winding wheel set comprises two winding wheels engaged with each other through a gear, and each winding wheel is coaxially coupled to a winding shaft, and an end of the worm spring is latched to the winding wheel; the guiding element has a guide wheel set installed therein, and the drawstring is wound around the guide wheel set and guided to the spring box element, and an end of the drawstring guiding to the spring box element is wound around the winding shaft.

In the aforementioned technical solution, the venetian blind retracting mechanism further comprises a vane directional switching member; and the vane directional switching member comprises a directional switching wheel and a ladder; the vanes are inserted into the ladder sequentially, and the longitudinal drawstring of the ladder is fixed on both sides of the directional switching wheel separately.

In the aforementioned technical solution, there are two vane directional switching members disposed on both sides of the spring box element respectively.

In the aforementioned technical solution, the directional switching wheels of the two vane directional switching members are coaxially coupled to each other through a linking shaft.

In the aforementioned technical solution, the venetian blind retracting mechanism further comprises a rotating element linked to the linking shaft for rotating the linking shaft to drive the directional switching wheel to rotate.

In the aforementioned technical solution, the rotating element includes a worm gear and a worm engaged with each other, and an end of the worm is formed into a rotating ring, and the linking shaft is passed and installed in the worm gear.

In the aforementioned technical solution, the casing is configured corresponsive to and pivoted to two winding wheel sets, and the winding wheels of the winding wheel sets are coaxially coupled to each other through the winding shaft; and both sides of the spring seat have the worm spring; and the worm springs on both sides of the spring seat are engaged with the winding wheels of the winding wheel sets respectively.

In the aforementioned technical solution, the winding wheel is engaged and coupled to the winding shaft.

In the aforementioned technical solution, the main body of the winding wheel is hinged and coupled to the winding shaft.

Compared with the prior art, the present invention has the following advantages and effects. The venetian blind retracting mechanism has the winding wheels engaged with each other to form the winding wheel set, so that the two winding shafts can wind or rewind the respective drawstrings simultaneously to retract both ends of the venetian blind at the same time and achieve balance, and prevent the vanes from tilting. In addition, the aforementioned simple and compact transmission structure formed by the spring box element and the guiding element does not have too many components that may bring up the issues of causing an asynchronous operation and lowering the production cost, so that the invention is suitable for promotion.

### BRIEF DESCRIPTION OF THE DRAWING

FIG. 1 is a perspective view of a conventional venetian blind;

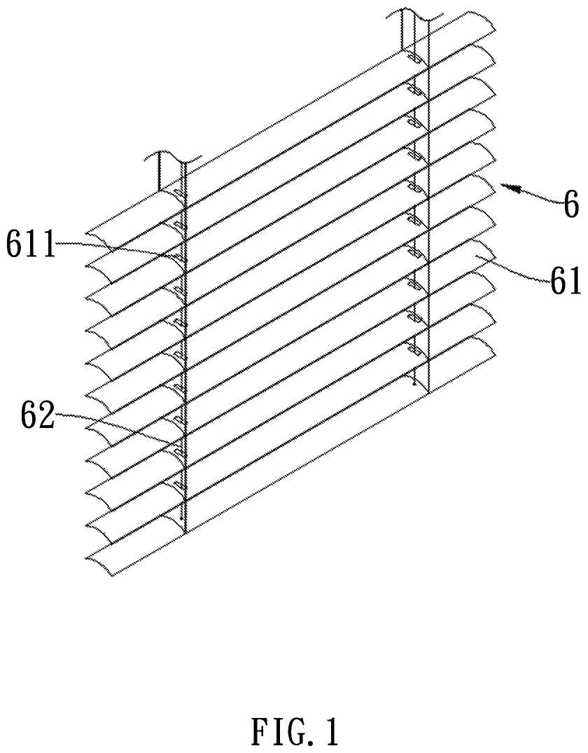

FIG. 2 is a perspective view of a venetian blind in accordance with a first embodiment of the present invention.

FIG. 3 is a schematic view of a venetian blind in accordance with the first embodiment of the present invention viewing from another direction;

FIG. 4 is a perspective view showing the internal structure of a venetian blind in accordance with the first embodiment of the present invention first embodiment;

FIG. 5 is an exploded view of a spring box element in accordance with the first embodiment of the present invention;

FIG. 6 is an exploded view of a winding wheel and a winding shaft in accordance with the first embodiment of the present invention;

FIG. 7 is a schematic view showing the structure of a guiding element in accordance with the first embodiment of the present invention;

FIG. 8 is an exploded view of a guiding element in accordance with the first embodiment of the present invention;

FIG. 9 is another schematic view of a guiding element in accordance with the first embodiment of the present invention viewing from another direction;

FIG. 10 is an exploded view of a guiding element in accordance with the first embodiment of the present invention viewing from another direction;

FIG. 11 is a cross-sectional view of a first embodiment of the present invention;

FIG. 12 is a partial blowup view of Section A of FIG. 11;

FIG. 13 is an exploded view of a vane directional switching member and a rotating element in accordance with the first embodiment of the present invention;

FIG. 14 is an exploded view of a spring box element in accordance with a second embodiment of the present invention;

FIG. 15 is a perspective view of a winding wheel and a winding shaft in accordance with the second embodiment of the present invention; and

FIG. 16 is an exploded view of a winding wheel and a winding shaft in accordance with the second embodiment of the present invention.

### DESCRIPTION OF THE PREFERRED EMBODIMENTS

The technical contents of the present invention will become apparent with the detailed description of preferred embodiments accompanied with the illustration of related drawings as follows. It is intended that the embodiments and figures disclosed herein are to be considered illustrative rather than restrictive.

### First Embodiment

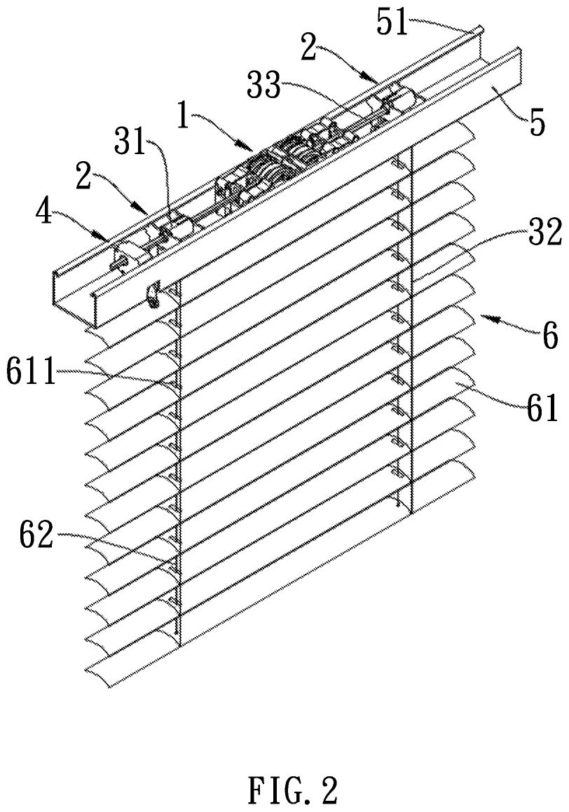

With reference to FIG. 2 for a venetian blind retracting mechanism of the first embodiment, the venetian blind retracting mechanism is applied for retracting a venetian blind 6, and the venetian blind 6 comprises two or more vanes 61 and drawstring 62; all vanes 61 are arranged sequentially in a vertical direction and parallel to each other; both ends of the venetian blind 6 have the drawstrings 62 respectively. In other words, there are two drawstrings 62, and they are disposed at both ends of the venetian blind 6 respectively. Besides the last vane 61 at the bottom 61 of the venetian blind 6, both ends of all other vanes 61 have a vane through-hole 611 at the same position, and the two drawstrings 62 are passed through the vane through-holes 611 sequentially and through all vanes 61 vertically, and the ends of the two drawstrings 62 are fixed to the last vane 61 at the bottom of the venetian blind 6. And the front ends of the two drawstrings 62 are passed out from the first vane 61 at the top of the venetian blind 6. If the front end of the drawstring 62 is pulled, the last vane 61 at the bottom is pulled first, and then the remaining vanes 61 of the venetian blind 6 are pulled from bottom to the top.

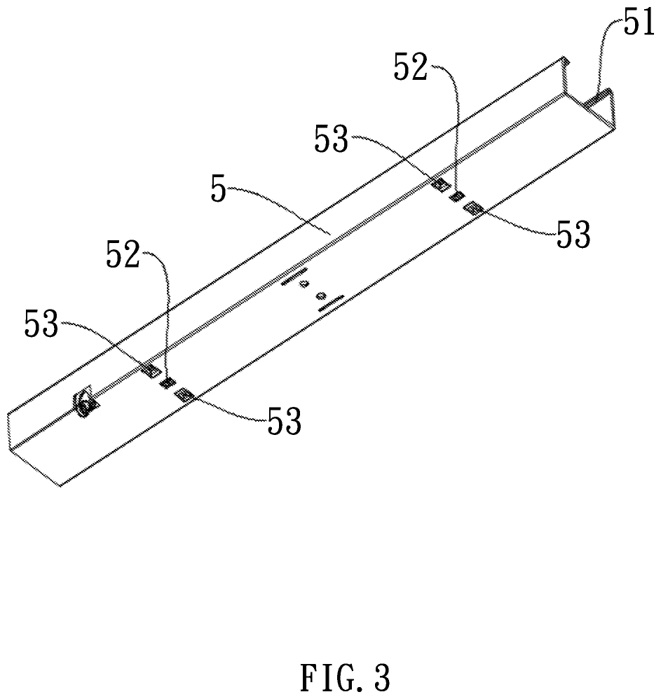

With reference to FIGS. 2 to 4 for a venetian blind retracting mechanism of the present invention, the venetian blind retracting mechanism comprises a spring box element 1, a guiding element 2, a vane directional switching member 3, a rotating element 4, and a window frame 5.

The window frame 5 is a frame made of light metal or engineering plastic, and the window frame 5 is a frame providing the whole support to the venetian blind retracting mechanism, and both side edges of the window frame 5 are bent and wound to form engaging edges 51.

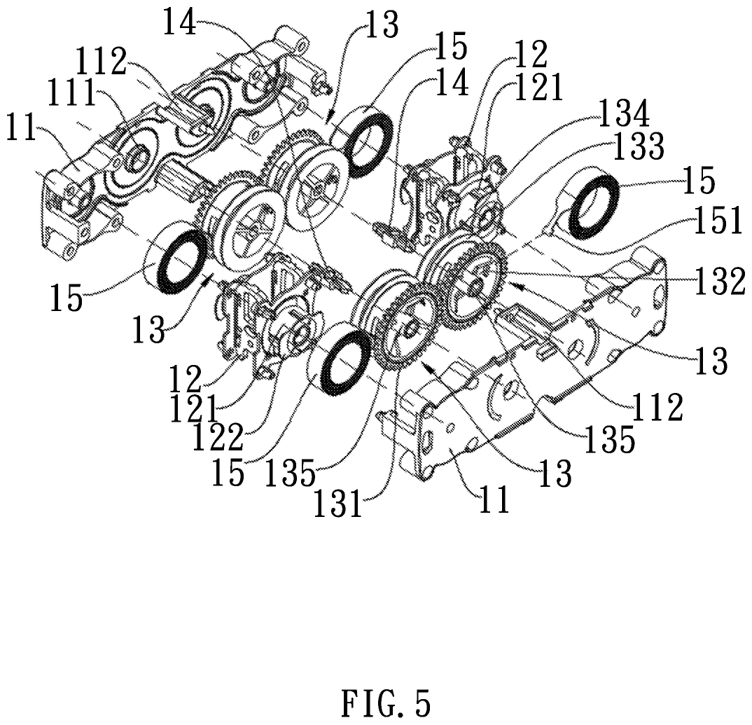

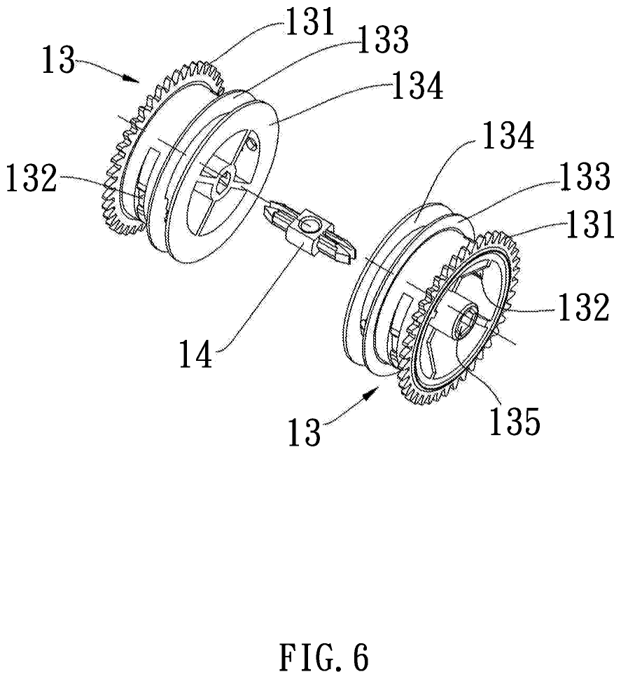

In FIGS. 5 and 6, the spring box element 1 comprises a casing 11, a spring seat 12, a winding wheel set, a winding shaft 14, and a worm spring 15.

There are two spring seats 12, both being frames made of an engineering plastic material. Both sides of each spring seat 12 have a cylindrical spring winding drum 121, and the front end of each spring winding drum 121 extends out from the first spring flap 122. Both sides of the spring seat 12 have the worm spring 15. Specifically, there are four worm springs 15 wound around the spring winding drums 121 of the spring seats 12. In other words, a worm spring 15 is wound around each spring winding drum 121, and the first spring flap 122 is provided for preventing the worm spring 15 from being dislocated. The casing 11 is formed by two components made of an engineering plastic material and extending to form the extension 112, and each component covers a side of the two spring seats 12, and two components are engaged with each other through the extension 112, so as to form a whole casing 11, and the casing 11 is provided for covering the worm spring 15.

The winding wheel set is pivoted to the casing 11. Specifically, each winding wheel set comprises two winding wheels 13 which are cylindrical wheel bodies made of an engineering plastic material; a 131 gear is formed on a distal surface of the winding wheel 13, and a ring-shaped second spring flap 133 is formed at the middle of the winding wheel 13, and a drawstring flap 134 is formed on the other distal surface of the winding wheel 13; a cylindrical pivot shaft 135 is formed at the middle shaft position of a distal surface of the winding wheel 13 wherein the gear 131 is formed; the winding wheel 13 has an engaging hole 132 formed on a side thereof and provided for engaging the worm spring 15; each component forming the casing 11 has two pivot sockets 111 formed thereon, and the pivot sockets 111 of two components are configured to be opposite and coaxial to each other after the assembling is completed; and the two winding wheels 13 of each winding wheel set are engaged with each other through the gear 131, and the method of inserting the pivot shaft 135 into the pivot socket 111 is used to set the two winding wheels 13 of the winding wheel set to be pivoted to the casing 11.

Specifically, there are two winding wheel sets, and each component of the casing 11 is pivoted to a winding wheel set. In other words, each component of the casing 11 is pivoted to two winding wheels 13, and the winding wheels 13 of the two winding wheel sets are configured to be opposite and coaxial to each other. Each winding wheel 13 is coaxially coupled to the winding shaft 14, and the winding wheel 13 of each winding wheel set is coaxially coupled through the winding shaft 14. Specifically, the winding shaft 14 has a plastic shaft body having buckles formed at both ends respectively and a through hole formed at the middle of the winding shaft 14 for passing the drawstring 62; both ends of the winding shaft 14 are engaged and inserted into the winding wheels 13 respectively, so that the two winding wheels 13 are configured to be opposite and coaxially coupled to each other through the same winding shaft 14, so as to achieve the effect of engaging the winding wheels 13 to the winding shaft 14.

After the assembling is completed, the spring seats 12 are disposed on both sides of the winding wheel set respectively; a connector 151 is formed at an end of the worm spring 15 and inserted into the engaging hole 132 of the winding wheel 13, so that an end of the worm spring 15 is engaged to the winding wheel 13 through the connector 151; the worm springs 15 disposed on both sides of the spring seat 12 are engaged to the winding wheels 13 of each winding wheel set respectively, so that each winding wheel 13 is engaged and coupled to one worm spring 15.

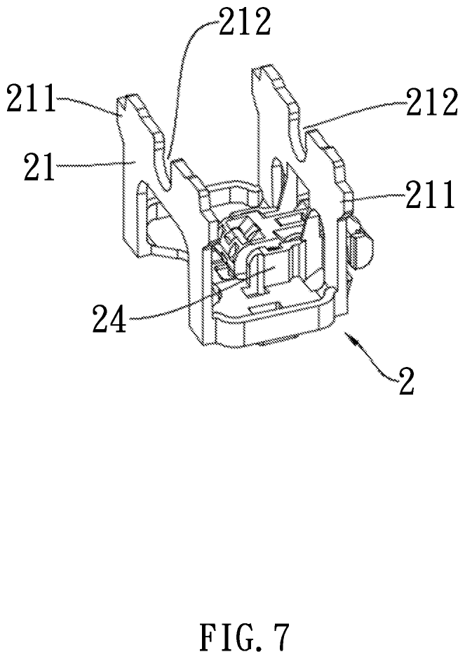

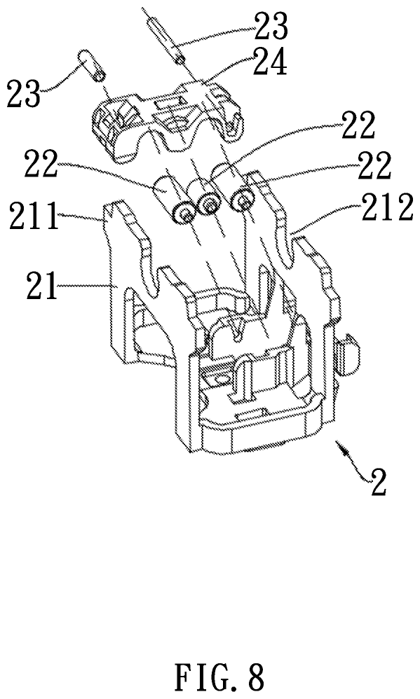

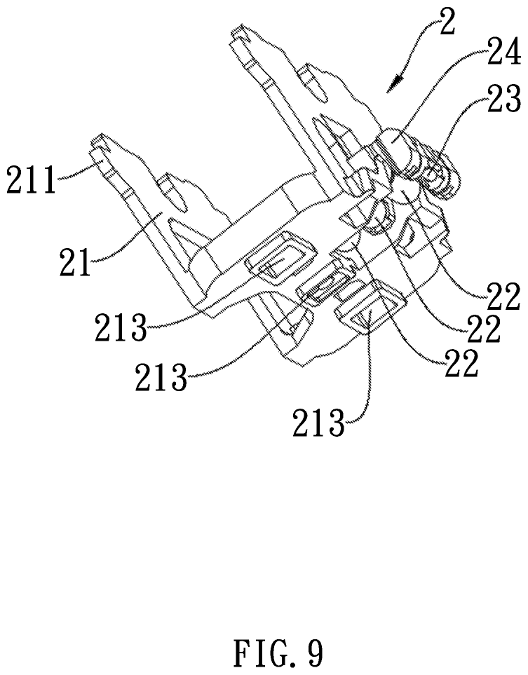

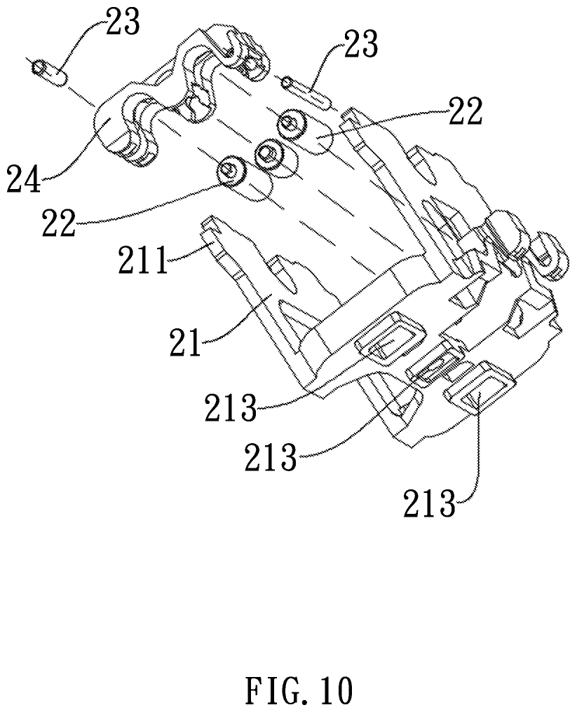

With reference to FIGS. 7 to 10, the guiding element 2 comprises a guiding seat 21, an engaging rib 211 formed on both sides of the guiding seat 21 separately and having a shape matched with the engaging edge 51; a guide wheel set installed in the guiding seat 21 of the guiding element 2 (specifically, a pivot socket 24 is formed at the lower part of the guiding seat 21); the guide wheel set includes three guide wheels 22, and the three guide wheels 22 are pivoted to the pivot socket 24; the front end and the rear end of the guide wheel set are pivoted to a guiding roller 23 separately, wherein the guiding roller 23 has a cross-sectional area smaller than that of the guide wheel set, and the guiding roller 23 is pivoted to the lower part of the pivot socket 24. Three through holes 213 are formed at the bottom of the guiding seat 21 and arranged linearly, and the through hole 213 at the middle is provided for passing the drawstring 62, and the through holes 213 on both sides are provided for passing the ladder.

A drawstring through hole 52 is formed at the bottom of the window frame 5; there are two drawstring through hole 52 formed on both sides of the bottom of the window frame 5; and two ladder through holes 53 are formed on both sides of each drawstring through hole 52 respectively. The spring box element 1 is embedded into the window frame 5 and fixed to the middle of the window frame 5 by screws; there are two guiding elements 2 embedded into the window frame 5 and disposed on the drawstring through hole 52, and the through hole 213 at the middle of the bottom of the guiding seat 21 is superimposed with the drawstring through hole 52, and the through holes 213 on both sides of the bottom of the guiding seat 21 are superimposed with the ladder through holes 53 respectively. The guiding element 2 is engaged with the engaging edge 51 through the engaging rib 211 to achieve the effect of fixing and connecting the window frame 5. After the assembling is completed, the two guiding elements 2 are disposed on both sides of the spring box element 1 respectively and a gap from the spring box element 1 is maintained.

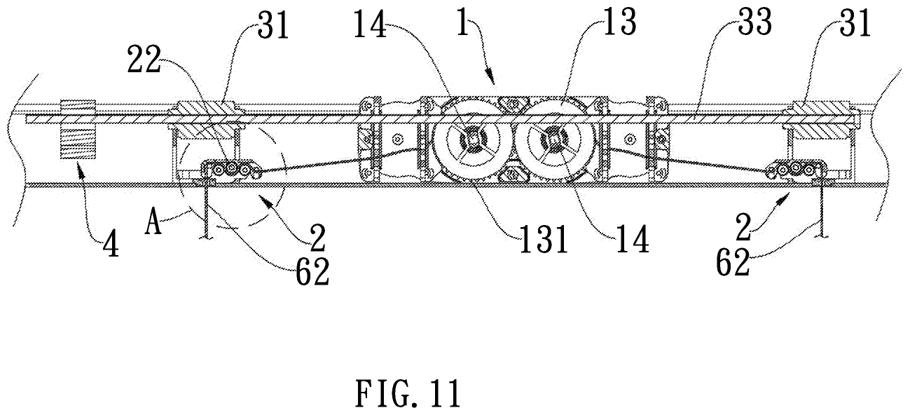

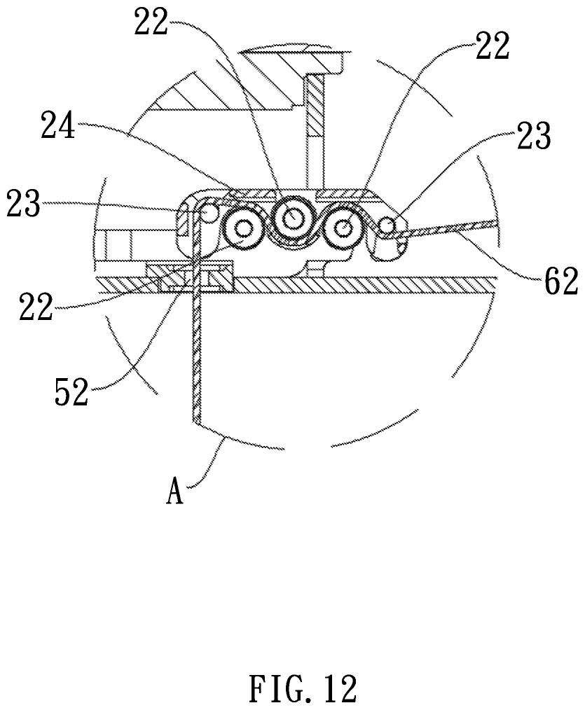

In FIGS. 11 and 12, after the upper end of the drawstring 62 is passed through the drawstring through hole 52 and the through hole 213 at the middle of the guiding seat 21 and entered into the guiding element 2, the drawstring 62 is wound around one of the guiding roller 23, the three guide wheels 22 of the guide wheel set and the other guiding roller 23 sequentially and then guided in a direction towards the spring box element 1 and wound around one winding shaft 14 of the spring box element 1. When the drawstring 62 is wound around the winding shaft 14, the string head is passed through the through hole at the middle of the winding shaft 14, so that the drawstring 62 is coupled to the winding shaft 14 securely.

When the venetian blind retracting mechanism is used together with the venetian blind 6 and it is necessary to descend the venetian blind 6, the users may pull the last vane 61 at the bottom of the venetian blind 6 downwardly, and the vane 61 will pull the drawstring 62. When the drawstring 62 is pulled, the winding shaft 14 starts rotating and gradually release the drawstring 62 while the winding wheel 13 is rotating, and the worm spring 15 is pulled, and the worm spring 15 is released gradually from the spring winding drum 121 and wound onto the winding wheel 13. Since the two winding wheels 13 of the same winding wheel set are engaged with each other through the gear 131, and configured to be opposite and coaxially coupled to the winding wheel 13 through the winding shaft 14, so that the four winding wheels 13 can be rotated synchronously and wound on the worm spring 15, and the two winding shafts 14 can release the respective drawstrings 62 simultaneously.

When the venetian blind 6 is descended to the desired height, users may release their hands, and a resultant force is formed by the gravity of the venetian blind 6 and the friction between the drawstrings 62 and the guide wheel set, wherein the resultant force and the resilience of the worm spring 15 maintains a balance, so that the venetian blind 6 can be maintained at the desired height.

When it is necessary to ascend the venetian blind 6, the users may push the last vane 61 at the bottom of the venetian blind 6. Now, the pushing force of the users offsets the gravity of the venetian blind 6, and the resultant force formed by the gravity of the venetian blind 6 and the friction between the drawstrings 62 and the guide wheel set is insufficient to overcome the resilience produced by the worm spring 15, so that the worm spring 15 is rewound onto the spring winding drum 121 quickly, and the winding wheel 13 is pulled to rotate in an opposite direction, so as to rotate the winding shaft 14 in the opposite direction to rewind the drawstring 62, and the drawstring 62 ascends the venetian blind 6 quickly. Since the two winding wheels 13 of the same winding wheel set are engaged to each other through the gear 131 and configured to be opposite and coaxially coupled to through the winding shaft 14, so that the four winding wheels 13 can be rotated in the opposite direction synchronously, and the two winding shafts 14 rewind the respective drawstrings 62 simultaneously.

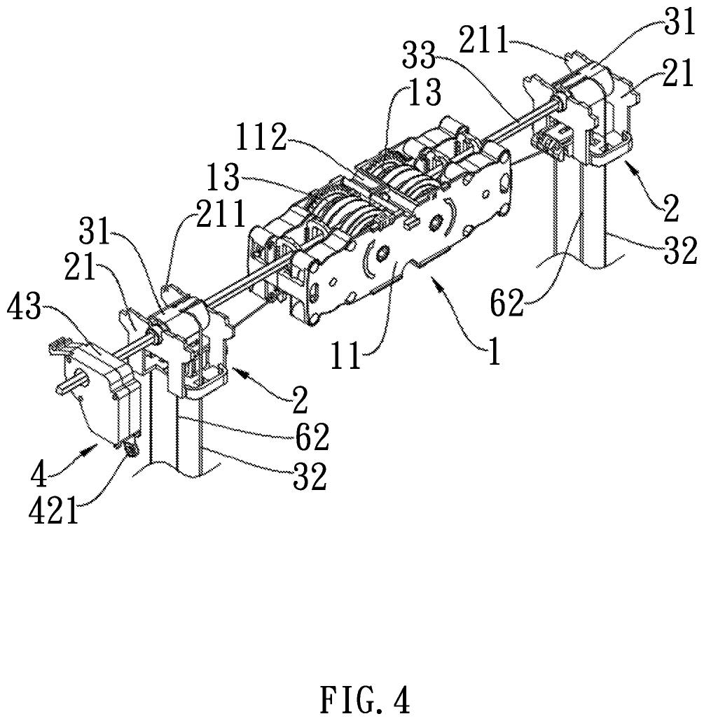

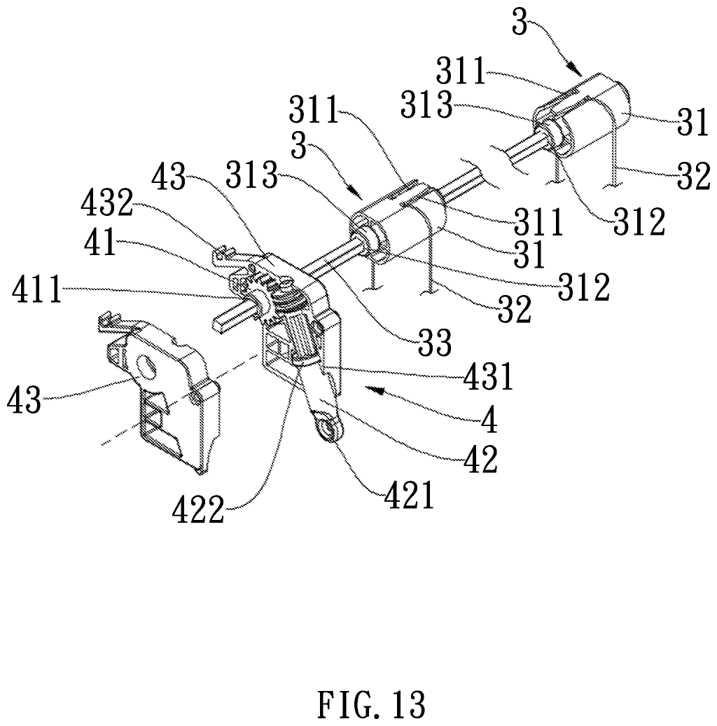

In FIGS. 4 and 13, the venetian blind retracting mechanism further comprises a vane directional switching member 3, and the vane directional switching member includes a directional switching wheel 31 and a ladder 32. From the side view, the ladder 32 is comprised of two parallel longitudinal drawstrings and two or more parallel latitudinal drawstrings, and the head and tail of the latitudinal drawstrings are coupled to the two longitudinal drawstrings respectively to define a quadrilateral space; all vanes 61 of the venetian blind 6 are inserted into the quadrilateral space of the ladder 32 sequentially; if one of the longitudinal drawstrings is pulled, all vanes 61 of the venetian blind 6 will be rotated in one of the directions, and if the other longitudinal drawstring is pulled, all vanes 61 of the venetian blind 6 will be rotated in another direction. The directional switching wheel 31 is a workpiece made of an engineering plastic material, whose upper surface has two engaging slots 311 formed thereon; both ends of the directional switching wheel 31 extend out from the shaft 313, and the shaft 313 has a square through hole (which is referred to as a first square hole 312) formed thereon and axially penetrating through the directional switching wheel 31; two arc notches 212 are formed at the top of the guiding seat 21, and the two shafts 313 are mounted onto the notches 212 respectively. Two ladder through holes 53 are formed on both sides of the drawstring through hole 52 of the window frame 5 respectively. After the upper ends of the two longitudinal drawstrings of the ladder 32 are passed through the ladder through holes 53 and embedded into the two engaging slots 311 of the directional switching wheel 31 and tied to achieve the effect of connecting and fixing the upper end of the ladder 32 to the directional switching wheel 31. When the directional switching wheel 31 is rotated in a direction, and one of the longitudinal drawstrings is pulled, all vanes 61 of the venetian blind 6 are rotated in one of the directions. Similarly, when the directional switching wheel 31 is rotated in another direction and the other longitudinal drawstring is pulled, all vanes 61 of the venetian blind 6 are rotated in the other direction. The aforementioned process can change the luminous flux of the venetian blind 6 to change indoor brightness.

Further, there are two vane directional switching members 3 disposed on both sides of the spring box element 1 respectively. The guiding elements 2 are disposed on both sides of the spring box element 1 respectively, and the directional switching wheel 31 is disposed at the upper part of the guiding seat 21 of each guiding element 2; and both ends of all vanes 61 of the venetian blind 6 are inserted into the quadrilateral space of the two ladders 32.

Further, the directional switching wheels 31 of the two vane directional switching members 3 are coaxially coupled through a linking shaft 33. Specifically, the linking shaft 33 has a square cross-section in a shape matched with that of the first square hole 312, and the linking shaft 33 is passed through the first square holes 312 of the two directional switching wheels 31 to achieve the effect of connecting the two directional switching wheels 31 coaxially. When one of the directional switching wheels 31 is rotated, the other directional switching wheel 31 is rotated simultaneously. When the linking shaft 33 is rotated, the two directional switching wheels 31 are rotated simultaneously. When the two directional switching wheels 31 are rotated simultaneously, the two ladders 32 are moved simultaneously, and forces are exerted at both ends of the vanes 61 to prevent the vanes 61 from shifting during the direction switching process.

Further, the venetian blind retracting mechanism further comprises a rotating element 4; the rotating element 4 comprises a worm gear 41, a worm 42 and a casing 43. The casing 43 is comprised of two components made of an engineering plastic material, and the interior of the casing 43 is a space provided for receiving the worm gear 41 and the worm 42; an engaging slot 432 is formed at an end of the casing 43 and matched with the engaging edge 51, and an embracing rib 431 is formed in the casing 43, wherein the embracing rib 431 is a rib extending towards the interior of the casing 43. A second square hole 411 is formed at an axial position of the worm gear 41 and in a shape matched with that of the linking shaft 33, and the worm gear 41 is pivoted to the interior of the casing 43, and the shaft and the second square hole 411 of the worm gear 41 are passed out from the casing 43. Spiral teeth are formed at an end of the worm 42, a convex ring 422 is formed at the middle of the worm 42, and a rotating ring 421 is formed at the other end of the worm 42. The convex ring 422 is a radial extension of the worm 42, and the rotating ring 421 is a ring-shaped structure formed at a distal surface of the worm 42. A spiral tooth of the worm 42 is engaged with the worm gear 41, and the convex ring 422 of the worm 42 is matched with the embracing rib 431 of the casing 43. In other words, the embracing rib 431 is engaged with the convex ring 422 to prevent the worm 42 from falling out the casing 43; the worm 42 is formed at an end of the rotating ring 421 and passed out from the casing 43. The casing 43 is passed through the engaging slot 432 and matched with the engaging edge 51 and embedded in the window frame 5; the linking shaft 33 is passed into the second square hole 411 of the worm gear 41; when the worm 42 is rotated, the worm gear 41 is linked to rotate, so as to rotate the two directional switching wheels 31 through the linkage of the linking shaft 33.

When the vanes 61 of the venetian blind 6 switch the rotating direction, a user may hold a long stick with a hook at the front end of the stick to hook the rotating ring 421 and then rotate the long stick in order to rotate the worm 42. When the worm 42 is rotated to link and rotate the worm gear 41, the two directional switching wheels 31 are rotated through the linkage of the linking shaft 33, so as to ascend one of the longitudinal drawstrings, and all vanes 61 of the venetian blind 6 are rotated in one direction to change the luminous flux.

The venetian blind retracting mechanism is engaged with the winding wheel 13 to form the winding wheel set, so that the two winding shafts 14 can retract their respective drawstrings 62 respectively, and both ends of the venetian blind 6 can be wound and rewound simultaneously to achieve balance and prevent the vanes 61 from tilting. In addition, the aforementioned simple transmission structure formed by the spring box element 1 and the guiding element 2 does not have too many components that may bring up the issues of causing an asynchronous operation and lowering the production cost, so that the invention is suitable for promotion.

### Second Embodiment

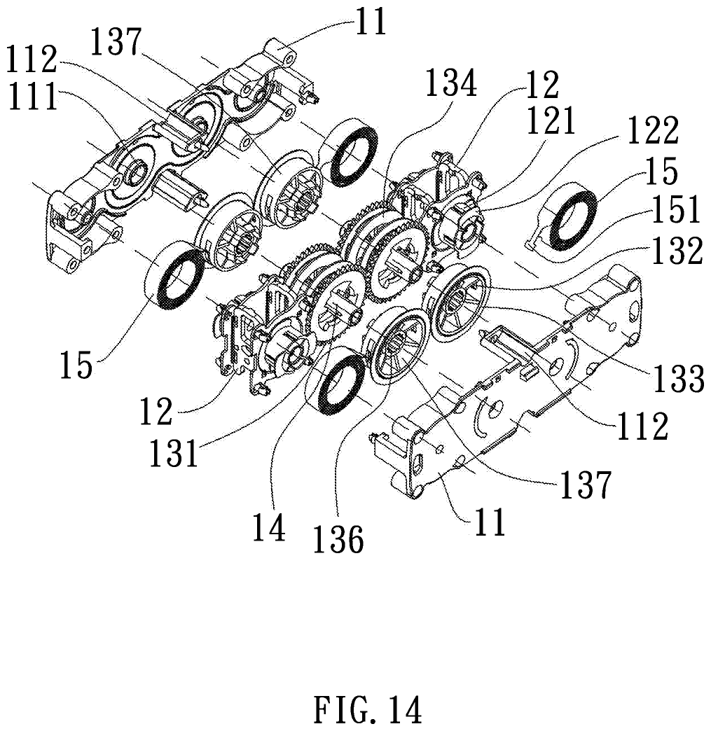

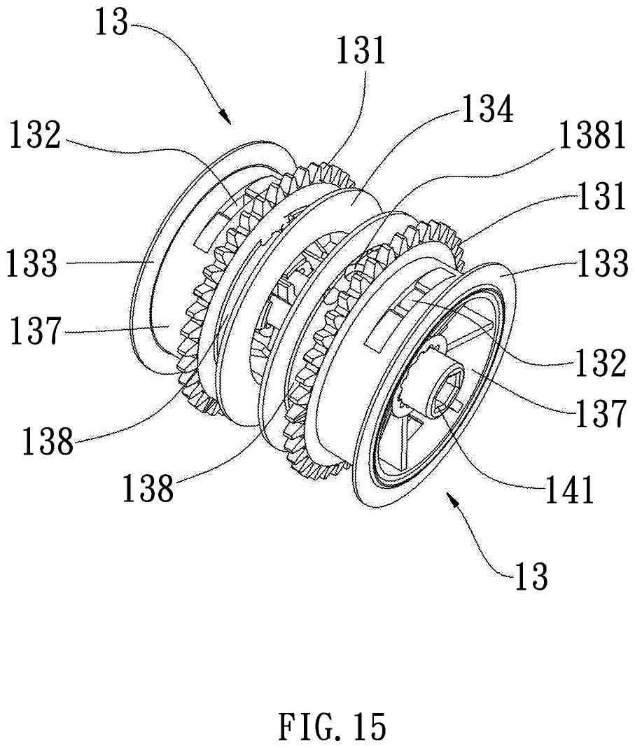

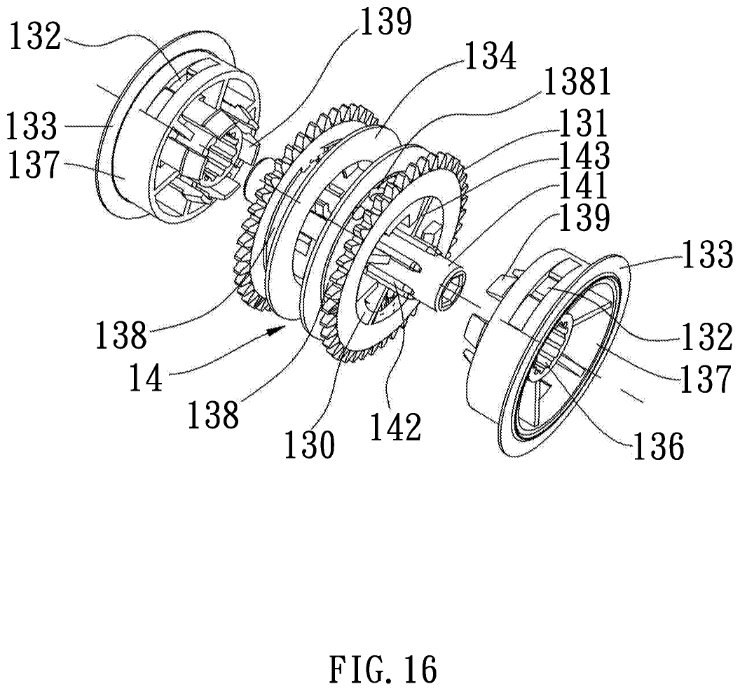

With reference to FIGS. 14 to 16 for a venetian blind retracting mechanism in accordance with a second embodiment of the present invention, the venetian blind retracting mechanism of this embodiment is substantially the same as the first embodiment except that the winding shaft 14 of this embodiment has a plastic shaft body, and both ends of the winding shaft 14 are not engaged but are coupled to the pivoting end 141 matched with the pivot socket 111 of the casing 11. Specifically, the winding shaft 14 has a cylindrical shaft body, and a radius equal to the internal radius of the pivot socket 111, so that both ends of the winding shaft 14 can be inserted into the pivot sockets 111 of the two components of the casing 11, wherein both end of the winding shaft 14 are the pivoting ends 141.

The winding wheel 13 has a split structure. Specifically, the main body of the winding wheel 13 is a wheel body made of an engineering plastic material, wherein the wheel body is called a winding wheel body 137, and an engaging hole 132 is formed on a side of the winding wheel body 137 and provided for engaging the worm spring 15; an axial position of the winding wheel body 137 is configured to be matched with the through hole of the winding shaft 14, and a key slot 136 is formed in the through hole, wherein the key slot 136 a flat key slot or a spline slot. In this embodiment, the key slot 136 is a spline slot; the gear 131 of the winding wheel 13 is integrally formed with the winding shaft 14. Specifically, the gear 131 is installed at the middle of the winding shaft 14 and coaxially and integrally formed with the winding shaft 14; a key 142 is formed on the shaft body of the winding shaft 14. In this embodiment, there are three keys 142 having an included angle of 120° with respect to each other and arranged in the circumferential direction of the cylindrical surface of the winding shaft 14; the winding wheel body 137 is sheathed on the winding shaft 14, so that the winding wheel body 137 abuts against the gear 131, and the key 142 and the key slot 136 are configured to be corresponsive to each other, and have an interference fit, so that the winding wheel body 137 and the winding shaft 14 are combined tightly. After the assembling process, the winding wheel body 137 is coaxially coupled to the winding shaft 14, and the pivoting end 141 is passed out from the through hole of the winding wheel body 137. In this embodiment, the second spring flap 133 is disposed on a distal surface of the winding wheel body 137. After the assembling is completed, the second spring flap 133 and the gear 131 are disposed two distal surfaces of the winding wheel body 137 respectively, and the drawstring flap 134 is disposed at the middle of the winding shaft 14 and integrally formed with the winding shaft 14. Viewing from the central axial direction of the winding shaft 14 towards the outside, we find that the drawstring flap 134, the gear 131, the winding wheel body 137 and the second spring flap 133 are installed sequentially; and the winding wheel body 137, the gear 131 and the drawstring flap 134 are combined to form a complete winding wheel 13, so as to achieve the effect of connecting the main body of the winding wheel 13 to the key of the winding shaft 14.

There are two combined structure of the winding shaft 14 and the winding wheel 13 and the two combined structure are disposed adjacent to each other, and the pivoting ends 141 of the two winding shafts 14 are inserted into two pivot sockets 111 of the casing 11 respectively. After the assembling is completed, the second spring flap 133 disposed on the winding wheel 13 is near the casing, and the gears 131 disposed on the two winding shafts 14 are engaged with each other to achieve the effect of engaging the two winding wheels 13 with each other through the gears 131, and the two winding wheels 13 are combined to form a winding wheel set through the mutual engagement of the gears 131.

In this embodiment, there are also two winding wheel sets, and each component of the casing 11 is pivoted to one winding wheel set. Specifically, both ends of the winding shaft 14 are pivoting ends 141, and each winding shaft 14 has two drawstring flaps 134 and two gears 131, wherein the two drawstring flaps 134 are symmetrical with respect to each other by using the center of the winding shaft 14 as the point of symmetry. In the meantime, the two gears 131 are also symmetrical with respect to each other by using the center of the winding shaft 14 as the point of symmetry, and a key 142 is disposed between the pivoting end 141 on both sides of the winding shaft 14 and the gear 131, and the winding shafts 14 are symmetrically sheathed on the two winding wheel bodies 137 by using the center of the winding shaft 14 as the point of symmetry, so that both sides of the winding shaft 14 have two winding wheels 13 respectively; the two pivoting ends 141 of the winding shaft 14 are inserted into the pivot sockets 111 of the two components of the casing 11 respectively, so that each component of the casing 11 is pivoted to one winding wheel set, and the winding wheels 13 of the two winding wheel sets are engaged with each other through their respective gears 131.

Similarly, after the assembling of the venetian blind retracting mechanism of this embodiment is completed, the spring seats 12 are disposed on both sides of the winding wheel set respectively, and the worm springs 15 on both sides of the spring seat 12 are engaged with the winding wheels 13 of the winding wheel sets respectively. In other words, an end of each worm spring 15 is engaged to the corresponding winding wheel 13 through the connector 151, so that each winding wheel 13 is coupled to one corresponding worm spring 15.

Further, the gear 131 and the drawstring flap 134 of this embodiment are coupled through a connecting ring 138, and the connecting ring 138 is integrally formed with the gear 131 and the drawstring flap 134; the winding shaft 14 has a support arm 143 formed thereon and provided for supporting the connecting ring 138, so as to support the gear 131 and the drawstring flap 134; the winding shaft 14, the support arm 143, the gear 131, the drawstring flap 134 and the connecting ring 138 are integrally formed; and a gap exists between the connecting ring 138 and the winding shaft 14, and the connecting ring 138 has a string tying hole 1381 formed thereon, and the string tying hole 1381 radially penetrates through the through hole of the connecting ring 138. When the drawstring 62 is wound on the winding shaft 14, the string head of the drawstring 62 is tied after passing through the string tying hole 1381, and then the drawstring 62 is guided to the winding shaft 14, and finally the drawstring 62 is wound on the winding shaft 14, so that the drawstring 62 and the winding shaft 14 can be coupled securely.

Further, the winding wheel body 137 has a connecting buckle 139 configured to be opposite to the other distal surface of the second spring flap 133, and an embracing ring 130 formed on the internal circumferential surface of the gear 131; after the winding wheel body 137 is sheathed on the winding shaft 14, the connecting buckle 139 is buckled with the embracing ring 130, so that the cooperation between the winding wheel body 137 and the winding shaft 14 is more stable.

The gear 131 and the winding shaft 14 are integrally formed, and the main body of the winding wheel 13 is coupled to the key of the winding shaft 14, so that the cooperation between the winding wheel 13 and the winding shaft 14 is more stable. Such arrangement prevents an insecure connection between the winding wheel 13 and the winding shaft 14 caused by the manufacturing tolerance of the plastic workpiece.

The remaining portion of the venetian blind retracting mechanism of this embodiment is the same as the venetian blind retracting mechanism of the first embodiment, and thus will not be repeated.

While the present invention has been described by means of specific embodiments, numerous modifications and variations could be made thereto by those skilled in the art without departing from the scope and spirit of the present invention set forth in the claims.

What is claimed is:

1. A venetian blind retracting mechanism, for retracting a venetian blind (6), and the venetian blind (6) comprising two or more vanes (61) and drawstrings (62); and both ends of the venetian blind (6) having the drawstrings (62) passing through all of the vanes (61) and coupled to the last vane (61) at the bottom of the venetian blind (6); characterized in that the venetian blind retracting mechanism comprises a spring box element (1) and a guiding element (2) separately disposed on both sides of the spring box element (1); the spring box element (1) comprises a casing (11), a winding wheel set pivotally coupled to the casing (11) and separately disposed at a spring seat (12) on both sides of the winding wheel set, and wound around a worm spring (15) installed on the spring seat (12); the winding wheel set comprises two winding wheels (13) engaged with each other through a gear (131), and each winding wheel (13) is coaxially coupled to a winding shaft (14), and an end of the worm spring (15) is latched to the winding wheel (13); the guiding element (2) has a guide wheel set installed therein, and the drawstring (62) is wound around the guide wheel set and guided to the spring box element (1), and an end of the drawstring (62) guiding to the spring box element (1) is wound around the winding shaft (14).

2. The venetian blind retracting mechanism according to claim 1, further comprising a vane directional switching member (3); the vane directional switching member (3) comprising a directional switching wheel (31) and a ladder (32); the vanes (61) being inserted into the ladder (32) sequentially, and the longitudinal drawstring of the ladder (32) being fixed on both sides of the directional switching wheel (31) separately.

3. The venetian blind retracting mechanism according to claim 2, wherein the vane directional switching member (3) comes with a quantity of two, and the two vane directional switching members (3) are disposed on both sides of the spring box element (1) respectively.

4. The venetian blind retracting mechanism according to claim 3, wherein the directional switching wheels (31) of the two vane directional switching members (3) are coaxially coupled to each other through a linking shaft (33).

5. The venetian blind retracting mechanism according to claim 4, further comprising a rotating element (4) linked to the linking shaft (33) for rotating the linking shaft (33) to drive the directional switching wheel (31) to rotate.

6. The venetian blind retracting mechanism according to claim 5, wherein the rotating element (4) includes a worm gear (41) and a worm (42) engaged with each other, and an end of the worm (42) is formed into a rotating ring (421), and the linking shaft (33) is passed and installed in the worm gear (41).

7. The venetian blind retracting mechanism according to claim 1, wherein the casing (11) is configured corresponsive to and pivoted to two winding wheel sets, and the winding wheels (13) of the winding wheel sets are coaxially coupled to each other through the winding shaft (14); and both sides of the spring seat (12) have the worm spring (15); and the worm springs (15) on both sides of the spring seat (12) are engaged with the winding wheels (13) of the winding wheel sets respectively.

8. The venetian blind retracting mechanism according to claim 1, wherein the winding wheel (13) is engaged and coupled to the winding shaft (14).

9. The venetian blind retracting mechanism according to claim 1, wherein the main body of the winding wheel (13) is hinged and coupled to the winding shaft (14).
